(19) United States
(12) Patent Application Publication
(10) Pub. No.: US 2025/0373018 A1
(43) Pub. Date: Dec. 4, 2025

(54) Variable VAR Module

(71) Applicant: Southern States, LLC, Hampton, GA (US)

(72) Inventors: Joseph R Rostron, McDonough, GA (US); Jiyuan Fan, Duluth, GA (US)

(21) Appl. No.: 19/227,453

(22) Filed: Jun. 3, 2025

Related U.S. Application Data
(60) Provisional application No. 63/655,139, filed on Jun. 3, 2024.

(51) Int. Cl. H02J 3/18; H02M 7/483

(52) U.S. Cl. CPC H02J 3/1821; H02J 3/1878; H02M 7/483; H02J 2300/24

(57) ABSTRACT

The variable VAR module utilizes an electronic inverter operating at a “boost voltage” that is only a small fraction of the full line voltage. Fo a distribution line voltage of 38 kV, a “boost voltage” of about 10% of the line voltage (i.e., 3.8 kV) is typically sufficient to boost the voltage and inject the VARs necessary to cause the power generated by load-side generation, such as a solar or wind farm, to flow into the power grid. Reducing the operating voltage of the high-power electronics by 90% produces a tremendous reduction in the cost of the power flow controller—in comparison to those operating at the full line voltage. The module also provides “four quadrant” phase angle control injecting variable VARs into the power line causing the load-side generation to flow in the desired direction while maintaining the desired voltage levels in response to monitored power line conditions.

### REFERENCE TO RELATED APPLICATION

This application claims priority to U.S. Provisional Pat. App. Ser. No. 63/655,139 filed Jun. 3, 2024, which is incorporated by reference.

### TECHNICAL FIELD

The present invention is directed to electric power systems and, more particularly, to a variable VAR (Volt-Amp Reactive) electric power flow controller.

### BACKGROUND

The electrical distribution grid in the United States is increasingly being used to provide connection points for distributed generation resources, also referred to as load-side generation, such as solar farms, wind generators, diesel generators, tidal generators, battery generators, etc. At the same time, computerized loads that are sensitive to power quality are increasingly being connected to the distribution network, such as cloud server farms, electric transportation, home and office computers, hospital equipment, telecommunication equipment, etc. In many instances, power quality sensitive loads are connected downstream from the distributed generators. In some cases, these generators and downstream loads are normally or occasionally disconnected from the interstate power grid known as distributed or island networks, with interstate power grid providing interconnection or back-up electric service. These dual trends place new challenges on operators of the distributed networks and the interstate power grids to maintain voltage stability and power quality on the networks.

Conventional electric power transmission and distribution systems utilize automatic reclosers including circuit breakers and sectionalizers to isolate faults. After initially opening (generally referred to as “tripping”), most conventional reclosers automatically attempt to reclose one to five times over a period of several seconds according to a pre-set, timer-based reclose sequence to give the fault a chance to clear without further action. A fault can clear by itself, for example, when a lightning strike is over or when a tree branch falls away after momentarily causing a line fault. If the fault persists after the pre-set number of reclosing attempts, the recloser locks open requiring a manual reset once the fault has been cleared. These sectionalizing operations can cause transient power disturbances that adversely power quality sensitive loads. Motor and transformer switching can also cause transient power disturbances that adversely power quality sensitive loads.

The existing network has evolved over time and was not designed for two-way power flow or loads that are highly sensitive to power quality. Over the years, electric utilities have used voltage regulators and pole top capacitors to maintain voltage stability and provide reactive power (known as Volt-Amp Reactive or VAR) support for electric distribution networks. However, this traditional solution is proving to be inadequate at certain key locations where a faster and more effective response is needed to control the system voltage and VAR power flow to maintain power service quality and stability. As it is not practical or economical to completely rebuild the interstate power grid to meet the new challenges, there is a growing need for incremental and adaptive power flow control devices to meet these increasingly prevalent challenges.

For example, load-side electronic power generation stations, such as solar and wind generation farms, often present a power delivery challenge because they do not inherently produce sufficient voltage and reactive power (VARs) to inject the power generated into the power grid under typical operating conditions. While high-power electronic power flow controllers have been developed to generate sufficient voltage and VARs to reliably inject the load-side power generated by solar farm upstream into the power grid, conventional power flow controllers utilize electronic inverters operating at the full line voltage to generate the voltage boost and VARs required to inject the load-side generation upstream into the power grid. This is an expensive solution due to the utilization of electronic inverters operating at the full line voltage. The high expense limits the application of this technology to a relatively small number of large load-side generation sites that can support the high cost of the high voltage VAR control technology. A continuing need therefore exists for more economical VAR control systems.

### SUMMARY

The present invention solves the problem described above through a variable VAR module utilizes an electronic inverter operating at a “boost voltage” that is only a small fraction of the full line voltage. Fo a distribution line voltage of 38 kV, a “boost voltage” of about 10% of the line voltage (i.e., 3.8 kV) is typically sufficient to boost the voltage and inject the VARs necessary to cause the power generated by load-side generation, such as a solar or wind farm, to flow into the power grid. Reducing the operating voltage of the high-power electronics by 90% produces a tremendous reduction in the cost of the power flow controller—in comparison to those operating at the full line voltage. The module also provides “four quadrant” phase angle control injecting variable VARs into the power line causing the load-side generation to flow in the desired direction while maintaining the desired voltage levels in response to monitored power line conditions.

It will be understood that specific embodiments may include a variety of features in different combinations, and that all of the features described in this disclosure, or any particular set of features, need to be included in particular embodiments. The specific techniques and structures for implementing particular embodiments of the invention and accomplishing the associated advantages will become apparent from the following detailed description of the embodiments and the appended drawings and claims.

### BRIEF DESCRIPTION OF THE FIGURES

The numerous advantages of the invention may be better understood with reference to the accompanying figures in which:

FIG. 1 is a one-line diagram of a representative embodiment of the variable VAR module.

FIG. 2 is a phasor diagram illustrating an example angular relationship between the input voltage (Vin), the current (I) and the output voltage (Vout) of the variable VAR module.

FIG. 3 is a waveform diagram illustrating an example voltage boost and phase shift between the input voltage (Vin) and the output voltage (Vout) of the variable VAR module.

FIG. 4 is a one-line diagram of an alternative embodiment of the variable VAR module deployed to convert a Voltage Regulator (VR) into a Distribution Flexible AC Transmissions Systems (dFACT).

FIG. 5 is a one-line diagram of another alternative embodiment of the variable VAR module operating at the full line voltage injecting a variable boost voltage.

### DESCRIPTION OF ILLUSTRATIVE EMBODIMENTS

The invention may be embodied in an improved power flow controller referred to as a “variable VAR module” utilizing an electronic inverter operating at a “boost voltage” that is only a small fraction of the full line voltage. For example, in a distribution class variable VAR module for a line voltage of 38 kV, a “boost voltage” of about 10% of the line voltage (i.e., 3.8 kV) is typically sufficient to create the voltage boost and VARs necessary to cause the power generated by the solar farm to flow into the power grid. Reducing the operating voltage of the high-power electronics by 90% produces a tremendous reduction in the cost of the power flow controller—in comparison to power flow controllers operating at the full line voltage. The variable VAR module also provides a fast electronic response including a variable voltage boost and “four quadrant” phase angle control to inject variable VAR power into the power line to cause load-side generation power to flow in the desired direction while maintaining the desired voltage levels in response to monitored power line conditions.

Although the variable VAR module can theoretically be deployed at any desired voltage, 1.5 kV-38 kV electric distribution systems are typical voltages for example embodiments. Embodiments of the variable VAR module may be deployed as a parallel “boost” power flow controller operating at a small percentage of the line voltage) or as an inline power flow controller operating at the full line voltage. In either case, the variable VAR module outputs VAR injection power including variable output voltage, and variable current for example from 0 to 600 Amps, at a desired phase angle with respect to the output voltage, thus producing variable VARs into the power line. The output voltage (Vout) may be from a few percent of the line voltage up to the full line voltage (also referred to as the system voltage) plus or minus a controller voltage gains (boost) or attenuation (drop). In an example referred to as the voltage boost embodiment, the variable voltage boost may be up to 10% of the system voltage, at any desired phase angle, also referred to as the power factor control or VAR generation.

The primary purpose of the variable VAR module is to inject electric current into the power system with a controllable voltage boost and four-quadrant phase angle control over the angle of the output voltage (Vout) relative to the input voltage (Vin), referred to as controllable VAR generation. In various embodiments, the variable VAR module may be electrically connected in parallel with the power line, in series (i.e., in-line) with the power line, may be powered by the power line, and may be electrically connected to the power line at the same voltage as the power line (also referred to a line potential) in an outdoor environment.

The conventional approach is to locate the power electronics in an enclosure essentially at ground potential. While locating the enclosure housing and power electronics at high voltage is done on series capacitor banks, electric utilities typically do this at the high voltage end of voltage regulators or transformers to achieve voltage changes or VAR changes. The enclosures housing the power electronics at high voltage can be modular and, therefore, sit on existing regulators as a retrofit and hence be easier to implement. The advantage of the shunt-connected variable VAR module is that the full electronics, mainly the variable inverter, is maintained at a much lower voltage referred to as the “boost” voltage, such as which is only ˜10% of the system voltage (power line potential). Which, at present economics, is typically in the range of 10% of the cost needed to accomplish an equivalent function utilizing a variable inverter operating at the full line potential.

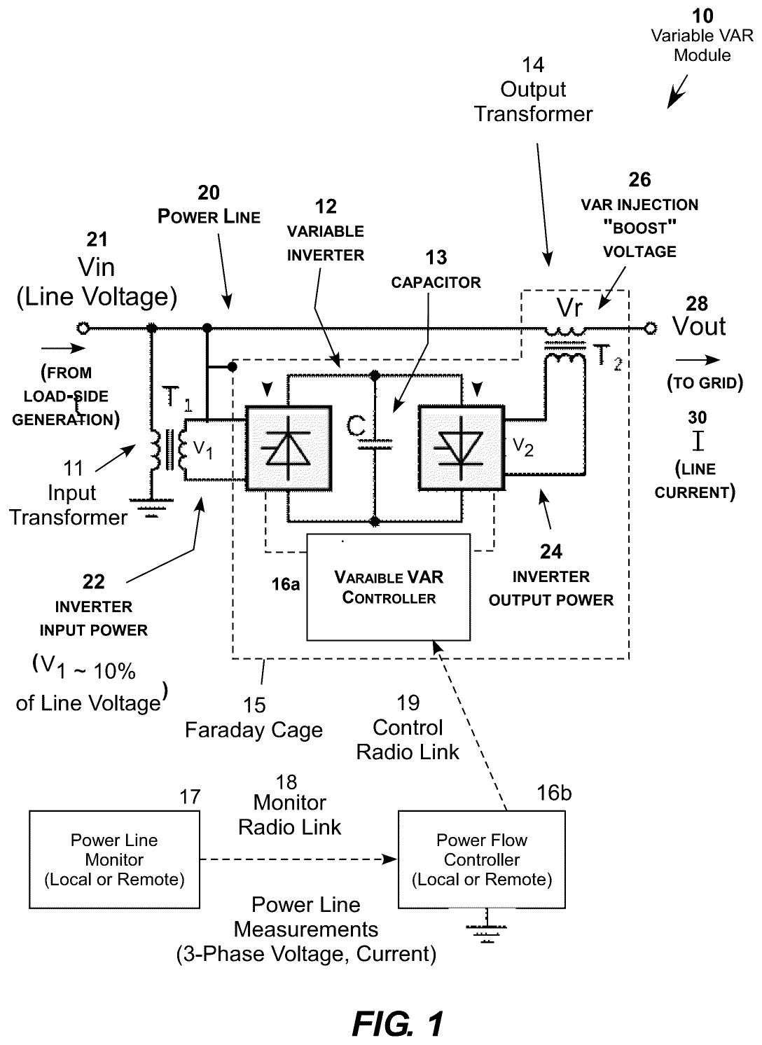

Referring now to illustrative embodiments, FIG. 1 is a one-line diagram of a variable VAR module 10, which is connected in parallel with the power line 20. The power line, in this example, has an input line voltage 21 (Vin) on the electrically downstream side of the variable VAR module, where load-side generation may be located, sometimes connected by a radial or “island” feeder; and an output line voltage 28 (Vout) on the electrically upstream side of the variable VAR module, where the utility or generation operator has a need to to deliver the power from the load-side generation to serve loads on the interconnected power grid. This is, as noted previously, one important function of the variable VAR module 10, but not the only potential function. Other potential functions include voltage regulation, power quality management, power interchange regulation, emergency power flow control, and so forth.

The variable VAR module 10 includes an input transformer 11 (T1) with a primary winding connected in shunt between the power line 20 and electric ground. The secondary winding of the input transformer 11 produces the source of the “boost” voltage V1, in this example up to about 10% of the input line voltage 21, also referred to as the inverter input power 22. The inverter input power 22 energizes the variable inverter 12 including, in simplified terms, a parallel configuration of electronically controlled diodes and a “smoothing” or low-pass capacitor 13. For example, the electronically controlled diodes may be banks of high-power transistors, thyristors, insulated-gate bipolar transistors (IGBTs), silicon controller rectifiers (SCRs), or any other suitable type of electronically controllable high-power switching devices.

The electronically controlled diodes produce an output voltage V2, also referred to as the inverter output power 24, which is a variable phase shifted counterpart of the inverter input power 22. The variable phase shift between the inverter input power 22 and the inverter output power 24 is controlled by the firing pattern of the variable VAR controller 16a, which may be controlled directly or indirectly by a power flow controller 16b, which may be deployed internally or externally, locally or remotely, with respect to the variable VAR controller 16a. It will be appreciated that the elements of the variable inverter 12 are illustrated in simplified terms as each electrical element is typically implemented by a bank of such components and supporting electronics.

The inverter output power 24 is injected into the power line 20 by an output transformer 14 (T2) including a primary winding powered by the inverter output power 24 (V2), and a secondary winding in-line with the power line 20. The output transformer 14 injects the inverter output power 24 into the power line 20 effectively increasing the line voltage 21 (Vin) by the VAR injection “boost” voltage 26 (Vr), or more concisely the “boost” voltage. The inverter output power 24 also phase shifts the line voltage by the injected VARs, likewise phase shifting the line output voltage 28 (Vout) with respect to the line current 30 (I), thus improving the power factor of the power flowing on the power line 20. Importantly, the phase shift induced between the power line input voltage 21 (Vin) and the power line output voltage 28 (Vout), due to the injection of reactive power VARs into the power line 20, allows the power from the load-side generation on the downstream side of the variable VAR module 10 to flow to the upstream side of the variable VAR module.

To shield the variable inverter 12 from unwanted voltage and current induced from the power line 20, the variable inverter 12 is located electrically inside a Faraday cage 15, which is electrically connected to the power line. The Faraday cage 15 thus protects the variable inverter 12 from interference caused by any of a range of sources, such as electrical switching transients, lightning, electromagnetic pulse (EMP) etc. Accordingly, a control signal may be transmitted to the variable VAR controller 16a by radio wave, glass fiber or other induction resistant communication media. In this embodiment, for example, a power line monitor 17 measures the power factor on the power line 20 may be located locally or remotely with respect to the variable VAR module 10. The power line monitor 17 transmits power line data via a monitor radio link 18 to the power flow controller 16b. As these components are located outside the Faraday cage 15, the power flow controller 16b, in turn, relays the power line data via a radio control link 19 to the variable VAR controller 16a located inside the Faraday cage 15. The power flow controller 16b, which may be local or remote with respect to the variable VAR Module 10, is typically maintained at ground potential, while the power flow controller 16a is typically maintained at line potential.

As an option, in this embodiment the power flow controller 16a utilizes power line voltage and current measurements to drive the variable inverter 12 to produce the desired amount of voltage boost and VAR reactive power to cause the desired power flow control, for example to cause injection of the power generated by an electronic power source, such as a solar farm, into the power line. The power flow controller 16b typically receives the power line voltage and current measurements over the monitor radio link 18 from power line monitoring devices, such as current transformers and voltage (or voltage angle) monitors. It will be understood that the variable inverter 12 includes a microprocessor, memory, wireless radio, programmed computer logic, and other suitable electronic and other computer components allowing it to engage in the communications and control the operation of the variable inverter 12.

In representative embodiments, the voltage boost may up to a nominal 10% of the power line input voltage and the output power factor may be greater than 98%. More specifically, the input power factor may be less than 90% and the output power factor is greater than 98%.

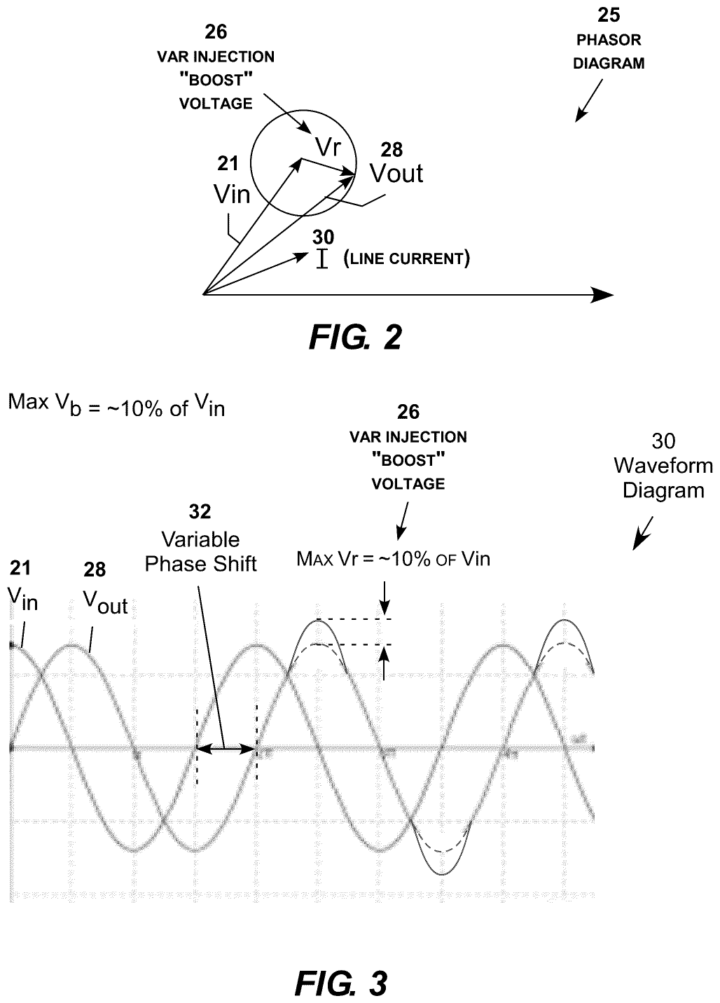

FIG. 2 is a phasor diagram illustrating an example angular relationship between the input voltage 21 (Vin), the output voltage 28 (Vout), the VAR injection “boost” voltage 26 (Vr), and the current 30 (I). FIG. 3 is a waveform diagram 30 illustrating the variable phase shift 32 between the input voltage 21 (Vin) and the output voltage 28 (Vout) of the variable VAR module 10. The VAR injection “boost” voltage 26 (Vr) or “boost voltage” is effectively added to the peak of the line voltage input voltage 21 (Vin) to produce phase shifted power line output voltage 28 (Vout). Engineers familiar with this area of technology will readily understand the phasor and waveform diagrams, which are visualizations of the theoretical mathematics of reactive power flow in an AC power system.

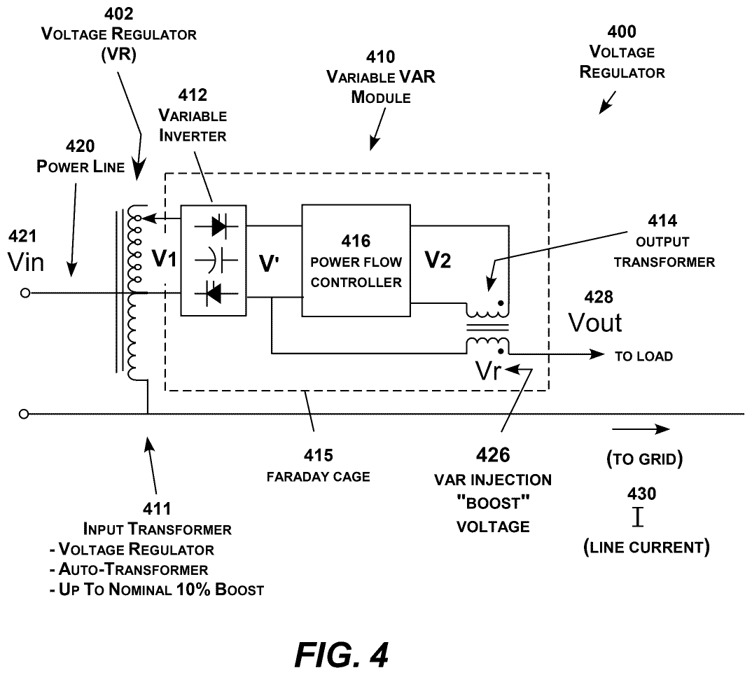

FIG. 4 is a one-line diagram of a voltage regulator 400, which is an alternative embodiment of the variable VAR module 410 deployed to convert a standard voltage regulator 402 (VR) into a Distribution Flexible AC Transmissions (dFACT) variable VAR power injection system. The standard voltage regulator 402 is connected in series with the power line 420 with the primary of the winding maintained at power line input voltage 421 (Vin). The secondary tap of the voltage regulator 402 is set to deliver the desired inverter input voltage V1 (analogous to the inverter input voltage V1 in FIG. 1) to the variable inverter 412, which delivers its output power, represented by the inverter output voltage V′, through or otherwise controlled by the power flow controller 416. The output from, or controlled by, the power flow controller 416 is represented by the output voltage V2 (analogous to the inverter output voltage V2 in FIG. 1). The output voltage V2 is connected across the primary winding of the output transformer 414. The secondary winding of the output transformer 414 is connected in series with the power line 420, producing the VAR injection “boost” voltage 426 (Vr), which is effectively added to the peak of the line voltage input voltage 421 (Vin) to produce phase shifted power line output voltage 428 (Vout), thus controlling the power factor between the phase shifted power line output voltage 428 and the line current 430 (I).

As with the variable VAR module 10 shown in FIG. 1, the variable VAR module 410 is located within the Faraday cage 415. It will be understood that analogs of the other elements of the controlling the variable VAR module 10 shown in FIG. 1 may likewise be deployed with the variable VAR module 410. It will be thus understood that the variable VAR module 410 may be effectively equivalent to the variable VAR module 10 shown in FIG. 1 with the exception of using the voltage regulator 402 (which may also be recognized as a type of autotransformer) as the power supply instead of the shunt-connected input transformer 11 (T1) used for the variable VAR module 10 in FIG. 1.

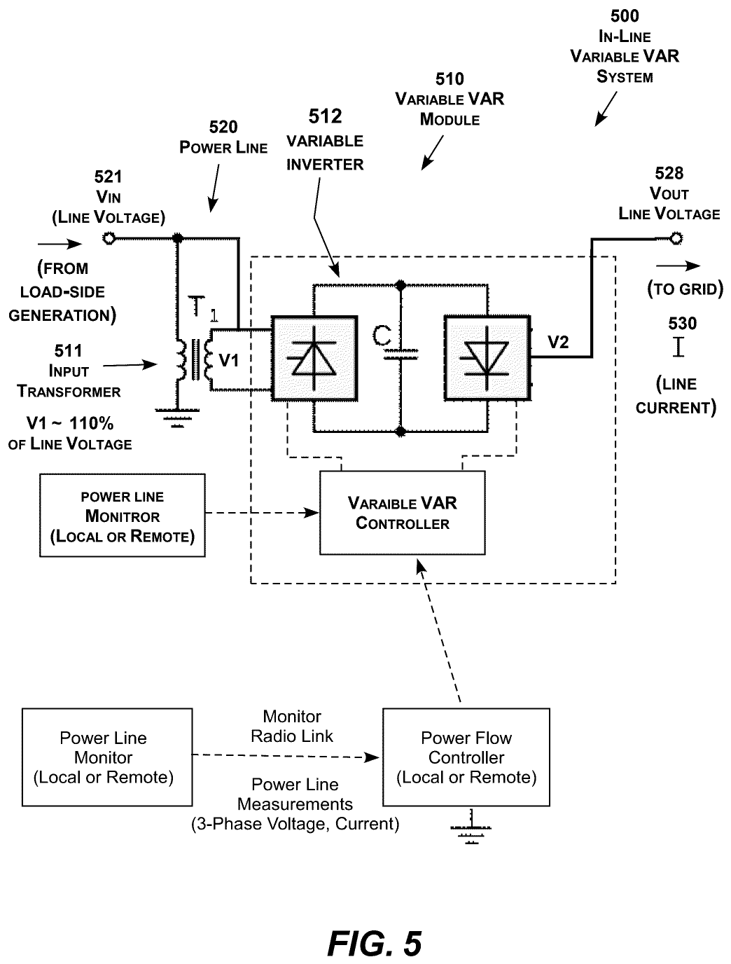

FIG. 5 is a one-line diagram of another alternative embodiment of the variable VAR module, in this example an in-line variable VAR system 500 operating at the full line voltage of the power line 520. That is, the in-line variable VAR system 500 includes a variable VAR module 510 connected in series with the power line 520, which effectively runs through the in-line variable VAR module, injecting a variable boost voltage and a controllable amount of VARS into the power line 520, which is equivalent to stating that in-line variable VAR module 510 controls the power factor of the power flowing o the power line 520, which is a representation of the phase angle between power line output voltage 528 and the power line current 530. In this embodiment, the output voltage V1 of the input transformer 511 (T1) is for this example 110% of the power line input voltage 521 (Vin). As a result, the variable inverter 512 operates 110% of the power line input voltage 521 (Vin), as opposed to only about 10% of the power line input voltage 21 (Vin) for the variable VAR module shown in FIG. 1. The variable inverter 512 imparts a variable phase shift to V1, effectively injecting VARS into the power line 520 thus controlling the power factor of the output power, which also experiences the voltage “boost” provided by the input transformer 511 (T1).

It will be understood that analogs of the other elements of the controlling the variable VAR module 10 shown in FIG. 1 may likewise be deployed with the variable VAR module 510. It will be thus understood that the variable VAR module 510 may have a similar function to the variable VAR module 10 shown in FIG. 1, with the substantial exception of the variable inverter 512 operating at the power line input voltage, in this example boosted by 10% as imparted by the input transformer 511 (T1). While this will most likely increase the cost of the variable inverter 512 substantially, the cost increase may be somewhat offset by obviating the need for an output transformer. This assumes that high-voltage power electronics are substantially more expensive than high-voltage transformers, which is the prevailing market conditions today but may change generally in the future, while the prevailing economic conditions may vary for different potential users of the technology due to availability of different types of electric components, access to high-power transformers (which may be owned boy other parties or controlled by different utilities, and so forth.

While an example embodiment has been described, it will be appreciated that the variable VAR module 10 may be used for power flow control purposes other than power injection from electronic generation sources. The module may utilize any suitable type of communications, electronics, and other design choices.

The drawings are in simplified form and are not to precise scale unless specifically indicated. The words “couple” and similar terms do not necessarily denote direct and immediate connections, but also include connections through intermediate elements or devices. Certain descriptors, such “first” and “second,” “top and bottom,” “upper” and “lower,” “inner” and “outer,” or similar relative terms may be employed to differentiate structures from each other. These descriptors are utilized as a matter of descriptive convenience and are not employed to implicitly limit the invention to any particular position or orientation. It will also be understood that specific embodiments may include a variety of features and options in different combinations, as may be desired by different users. Practicing the invention does not require utilization of all, or any particular combination, of these specific features or options.

This disclosure sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components may be combined to achieve a particular functionality can be seen as “associated with” each other such that the desired functionality is achieved, irrespective of architectures or intermediate components. Likewise, any two components so associated can also be viewed as being “connected”, or “coupled”, to each other to achieve the desired functionality, and any two components capable of being so associated can also be viewed as being “functionally connected” to each other to achieve the desired functionality. Specific examples of functional connection include but are not limited to physical connections and/or physically interacting components and/or wirelessly communicating and/or wirelessly interacting components and/or logically interacting and/or logically interacting components.

In view of the foregoing, it will be appreciated that present invention provides significant improvements power flow controllers. The foregoing relates only to the exemplary embodiments of the present invention, and that numerous changes may be made therein without departing from the spirit and scope of the invention as defined by the following claims.

The invention claimed is:

1. A variable Volt-Amp reactive (VAR) module for a power line carrying electric power defining a power line input voltage and an input power factor on an input side of the variable VAR module and a power line output voltage and an output power factor on an output side of the variable VAR module, comprising:
an input transformer comprising a primary coil shunt connected to the power line and a secondary coil producing an input power conditioning supply;
an output transformer comprising a primary coil and a secondary coil connected in series with the power line;
a variable inverter comprising an input receiving the input power conditioning supply from the secondary coil of the input transformer, further comprising an output delivering an output power conditioning supply to the primary coil of the output transformer;
a variable VAR controller causing the variable inverter to impart a variable phase shift between the input power conditioning supply and the output power conditioning supply for delivery of variable VARs to the secondary winding of the output transformer;
wherein the output power conditioning supply imparts a voltage boost to the power line with respect to the power line input voltage below 50% of the power line input voltage.

2. The variable Volt-Amp reactive (VAR) module of claim 1, connected to deliver load-side generation from an input side of the variable Volt-Amp reactive (VAR) module to an interconnected power grid connected to an output sic of the variable Volt-Amp reactive (VAR) module.

3. The variable Volt-Amp reactive (VAR) module of claim 1, wherein the input transformer comprises a primary coil connected in shunt to the power line and a secondar coil supplying input power to the variable inverter.

4. The variable Volt-Amp reactive (VAR) module of claim 1, wherein the input transformer comprises an autotransformer.

5. The variable Volt-Amp reactive (VAR) module of claim 1, wherein the input transformer comprises voltage regulator.

6. The variable Volt-Amp reactive (VAR) module of claim 1, wherein the input transformer comprises voltage regulator.

7. The variable Volt-Amp reactive (VAR) module of claim 1, wherein the voltage boost is up to a nominal 10% of the power line input voltage.

8. The variable Volt-Amp reactive (VAR) module of claim 1, wherein the output power factor is greater than 98%.

9. The variable Volt-Amp reactive (VAR) module of claim 1, wherein the input power factor is less than 90% and the output power factor is greater than 98%.

10. The variable Volt-Amp reactive (VAR) module of claim 1, wherein the variable inverter comprises banks of electronically controllable diodes selected from the group comprising high-power transistors, thyristors, insulated-gate bipolar transistors (IGBTs), and silicon controller rectifiers (SCRs).

11. A variable Volt-Amp reactive (VAR) module for a power line carrying electric power defining a power line input voltage and an input power factor on an input side of the variable VAR module and a power line output voltage and an output power factor on an output side of the variable VAR module, comprising:
a variable inverter;
an input transformer comprising a primary coil connected in series with the power line, and a secondary coil providing an input voltage to the variable inverter;
an output of the variable inverter connected to the power line;
a variable VAR controller causing the variable inverter to impart a variable phase shift between the input power conditioning supply and the output power conditioning supply for delivery of variable VARs to the secondary winding of the output transformer;
wherein the output power conditioning supply imparts a voltage boost to the power line with respect to the power line input voltage below 50% of the power line input voltage.

12. The variable Volt-Amp reactive (VAR) module of claim 11, connected to deliver load-side generation from an input side of the variable Volt-Amp reactive (VAR) module to an interconnected power grid connected to an output sic of the variable Volt-Amp reactive (VAR) module.

13. The variable Volt-Amp reactive (VAR) module of claim 11, wherein the input transformer comprises a primary coil connected in shunt to the power line and a secondar coil supplying input power to the variable inverter.

14. The variable Volt-Amp reactive (VAR) module of claim 11, wherein the input transformer comprises an autotransformer.

15. The variable Volt-Amp reactive (VAR) module of claim 11, wherein the input transformer comprises voltage regulator.

16. The variable Volt-Amp reactive (VAR) module of claim 11, wherein the input transformer comprises voltage regulator.

17. The variable Volt-Amp reactive (VAR) module of claim 11, wherein the voltage boost is up to a nominal 10% of the power line input voltage.

18. The variable Volt-Amp reactive (VAR) module of claim 11, wherein the output power factor is greater than 98%.

19. The variable Volt-Amp reactive (VAR) module of claim 11, wherein the input power factor is less than 90% and the output power factor is greater than 98%.

20. The variable Volt-Amp reactive (VAR) module of claim 11, wherein the variable inverter comprises banks of electronically controllable diodes selected from the group comprising high-power transistors, thyristors, insulated-gate bipolar transistors (IGBTs), and silicon controller rectifiers (SCRs)
